(19) United States
(12) Patent Application Publication
(10) Pub. No.: US 2026/0185615 A1
(43) Pub. Date: Jul. 2, 2026

(54) Inlet and outlet precision ceramic control valve

(71) Applicant: Xuancheng Gear Precision Industry Co., Ltd., XUANCHENG CITY (CN)

(72) Inventors: MANQIANG YIN, XUANCHENG CITY (CN); CHUNGHSING LAW, XUANCHENG CITY (CN)

(21) Appl. No.: 19/435,718

(22) Filed: Dec. 29, 2025

(30) Foreign Application Priority Data
Dec. 30, 2024 (CN) 2024232971018

(51) Int. Cl. F16K 3/08; F16K 27/04

(52) U.S. Cl. CPC F16K 3/08; F16K 27/045

(57) ABSTRACT

An inlet and outlet precision ceramic water control valve includes a valve housing, a valve stem, a rotating base, a movable valve disc, a fixed valve disc and a valve base. The valve housing has a containing space inside with an upper port. Two opposite stopping block protrudes from an inner wall of the containing space, creating two rotation paths within the valve housing. A plurality of limiting flanges are disposed in the upper port. The valve stem has a rod and a driving end. A positioning pin is inserted through the rod. At least one first water-stop ring and at least one second water-stop ring are respectively sleeved around the rod and the rotating base. The movable valve disc and the fixed valve disc have a through hole and a through aperture, respectively. A plurality of drain notches are disposed on an upper edge of the fixed valve disc.

### BACKGROUND OF THE INVENTION

### Field of Invention

The present invention relates to an inlet and outlet precision ceramic water control valve.

### Description of the Related Art

Currently, faucets and other water supply appliances are equipped with a precision ceramic control valve to control the opening and closing of the water supply and the flow rate. A typical precision ceramic control valve consists of a valve stem, a movable valve disc, and a fixed valve disc housed within a valve housing, and a valve base is attached to the open end of valve housing. The valve stem extends from the valve housing and rotates during operation, causing the movable valve disc to align its through hole with the through aperture of the fixed valve disc, which allows water to flow in and out through the outlet of the valve base. Conversely, if the valve stem is rotated back, the through hole of the movable valve disc moves away from the through aperture of the fixed valve disc, blocking the water flow and shutting it off.

However, the conventional structure described above still has the following problems in practical applications: First, the rotation range of the valve stem is not limited, so the rotation force must be carefully controlled when opening and closing. Precision ceramic control valves that cannot accurately stop the valve stem at the open or closed position do not have good usability. Second, water sources inevitably contain impurities. When water with impurities flows through the inside of the precision ceramic control valve for a long time, some impurities will inevitably accumulate between the movable valve disc and the fixed valve disc, making the movable valve disc and the fixed valve disc prone to jamming due to the accumulation of impurities. Third, the valve stem is directly inserted into the valve housing and then extends outward, which cannot provide a guiding effect on the valve stem, making it prone to tilting after extension.

Therefore, it is desirable to provide an inlet and outlet precision ceramic water control valve to mitigate and/or obviate the aforementioned problems.

### SUMMARY OF THE INVENTION

An objective of present invention is to provide an inlet and outlet precision ceramic water control valve, which is capable of improving the above-mention problems.

In order to achieve the above-mentioned objective, an inlet and outlet precision ceramic control valve has a valve housing, a valve stem, a rotating base, a movable valve disc, a fixed valve disc, and a valve base; wherein:
the valve housing has a containing space with an upper port; the valve stem, rotating base, movable valve disc, and fixed valve disc are sequentially placed into the containing space, allowing the valve stem to pass through the valve housing via the upper port; two opposing stopping blocks respectively protrude from an inner wall of the containing space, creating two rotation paths within the valve housing; the upper port has a plurality of limiting flanges, and the containing space has at least one outlet penetrating laterally through the valve housing;
the valve stem has a rod and a driving end connected to the rotating base; a positioning pin is disposed through the rod, both ends of the positioning pin extending horizontally out of the rod; when the valve stem is placed into the valve housing, the rod is capable of passing through the upper port and ensuring that the two ends of the limiting pin extending from the rod are accommodated in the two rotation paths; the limiting flange guides the rod, preventing the rod from skewing during insertion; at least one first water-stop ring and at least one second water-stop ring are respectively sleeved around an outer periphery of the rod and the rotating base;
the movable valve disc has a through hole, and the fixed valve disc has a through aperture, and the movable valve disc and the fixed valve disc are stacked and placed into the containing space of the valve housing, allowing the fixed valve disc to be secured within the valve housing; the movable valve disc engages with the rotating base, and with rotation of the valve stem, the movable valve disc rotates with the rotating base, changing alignment of the through hole the through aperture to control opening and closing of a water supply or alter a flow rate; a plurality of drain notches are disposed on an upper edge of the fixed valve disc, configured to allow impurities flowing between the valve disc and the fixed valve disc to drain away, preventing impurities from accumulating between the movable valve disc and the fixed valve disc;
the valve base being combined with the valve housing prevents the fixed valve disc, the movable valve disc, the rotating base, and the valve stem from falling out of the containing space; and the valve base has a water inlet, allowing water to enter the containing space.

### BRIEF DESCRIPTION OF THE DRAWINGS

FIG. 1 is a 3D assembly drawing of a preferred embodiment according to the present invention.

FIG. 2 is a 3D exploded view of the preferred embodiment according to the present invention.

FIG. 3 is a valve discs alignment diagram when the water is turned off according to the present invention.

FIG. 4 is an assembled cross-sectional view of the preferred embodiment according to the present invention.

FIG. 5 is a cross-sectional view of A-A line shown in FIG. 4 of the preferred embodiment according to the present invention.

FIG. 6 is a cross-sectional view of B-B shown in FIG. 4 of the preferred embodiment according to the present invention.

FIG. 7 is a rotation state drawing of the valve stem of the preferred embodiment according to the present invention.

FIG. 8 is a limiting schematic drawing of the valve stem during rotation according to the present invention.

FIG. 9 is a valve alignment schematic drawing when the water is turned on according to the present invention.

### DETAILED DESCRIPTION OF THE PREFERRED EMBODIMENT

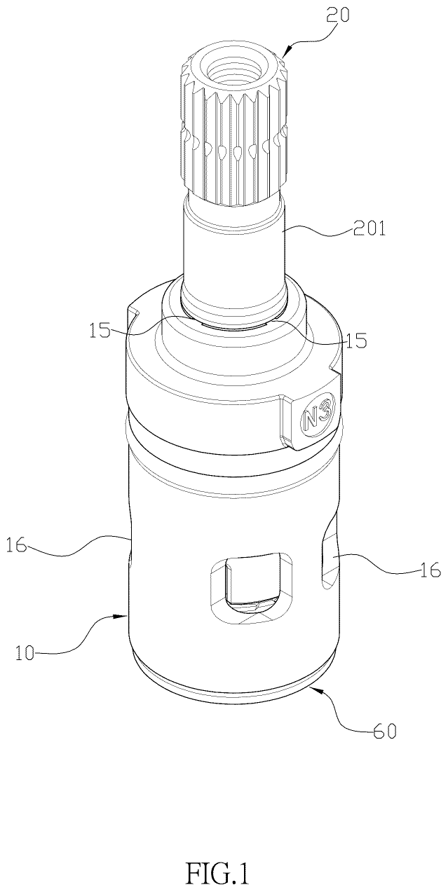

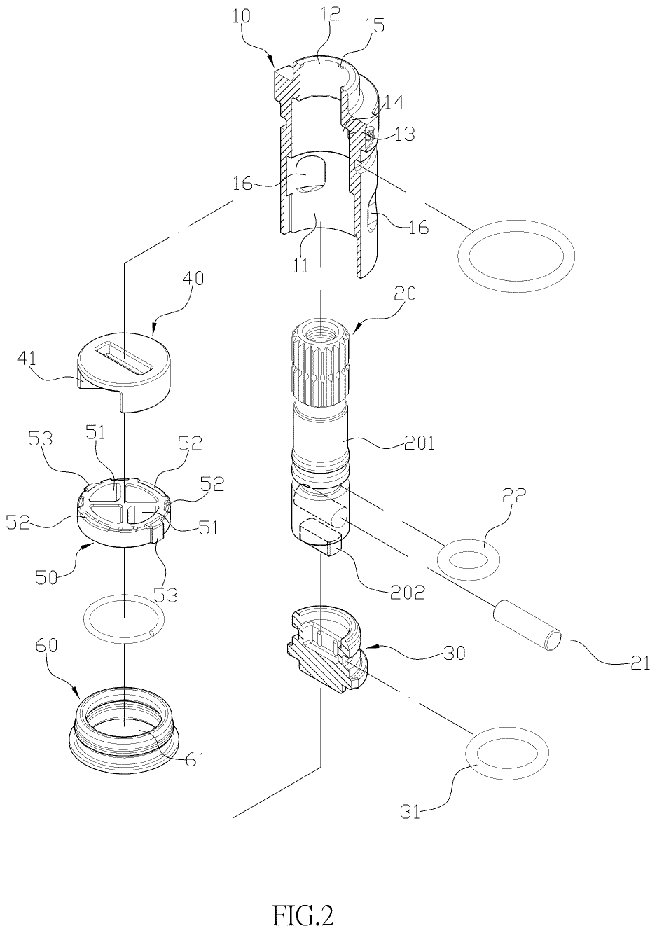

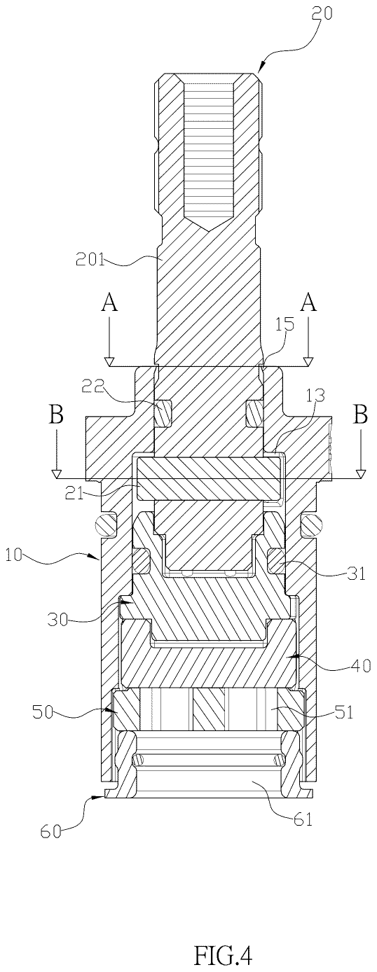

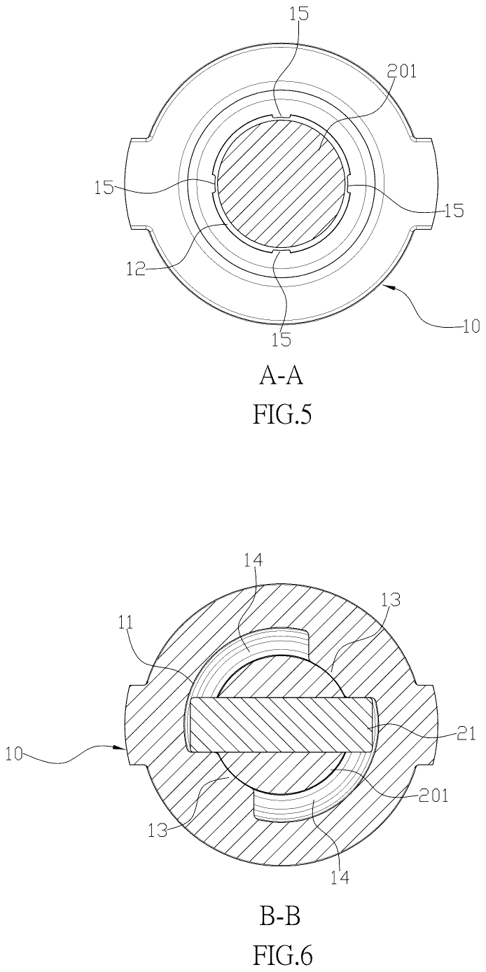

First, please refer to FIGS. 1 to 6. An inlet and outlet precision ceramic control valve comprises: a valve housing 10, a valve stem 20, a rotating base 30, a movable valve disc 40, a fixed valve disc 50 and a valve base 60. The valve housing 10 has a containing space 11 with an upper port 12. The valve stem 20, the rotating base 30, the movable valve disc 40 and the fixed valve disc 50 are sequentially placed into the containing space 11, which allows the valve stem 20 to pass through the valve housing 10 via the upper port 12. Two opposing stopping blocks 13 respectively protrude from an inner wall of the containing space 11, creating two rotation paths 14 within the valve housing 10. The upper port 12 has a plurality of limiting flanges 15, and the containing space 11 has at least one outlet 16 penetrating laterally through the valve housing 10. The valve stem 20 has a rod 201 and a driving end 202 connected to the rotating base 30. A positioning pin 21 is disposed through the rod 201, and both ends of the positioning pin 21 extending horizontally out of the rod 201. When the valve stem 20 is placed into the valve housing 10, the rod 201 is capable of passing through the upper port 12 and ensuring that the two ends of the limiting pin 21 extending from the rod 201 are accommodated in the two rotation paths 14. The limiting flange 15 guides the rod 201, preventing the rod 201 from skewing during insertion. Furthermore, at least one first water-stop ring 22 and at least one second water-stop ring 31 are respectively sleeved around an outer periphery of the rod 201 and the rotating base 30. The movable valve disc 40 has a through hole 41, and the fixed valve disc 50 has a through aperture 51. The movable valve disc 40 and the fixed valve disc 50 are stacked and placed into the containing space 11 of the valve housing 10, allowing the fixed valve disc 50 to be secured within the valve housing 10. The movable valve disc 40 engages with the rotating base 30, and with rotation of the valve stem 20, the movable valve disc 40 rotates with the rotating base 30, changing alignment of the through hole 41 and the through aperture 51 to control opening and closing of a water supply or alter a flow rate. A plurality of drain notches 52 are disposed on an upper edge of the fixed valve disc 50, configured to allow impurities flowing between the valve disc and the fixed valve disc to drain away, and preventing impurities from accumulating between the movable valve disc 40 and the fixed valve disc 50, which causes the movable valve disc 40 and the fixed valve disc 50 to become stuck together. The valve base 60 being combined with the valve housing 10 prevents the fixed valve disc 50, the movable valve disc 40, the rotating base 30 and the valve stem 20 from falling out of the containing space 11. The valve base 60 further has a water inlet 61, allowing water to enter the containing space 11.

Additionally, the upper port 12 has an inverted triangular limiting flange 15.

Moreover, the through hole 41 is a fan-shaped notch extending laterally through a periphery of the movable valve disc 40.

In addition, the through aperture 51 is fan-shaped.

Also, a periphery of the fixed valve disc 50 has a retaining rib 53 to secure the fixed valve disc 50 within the containing space 11 of the valve housing 10.

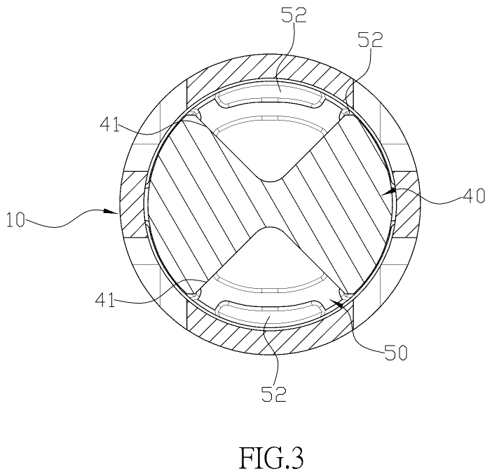

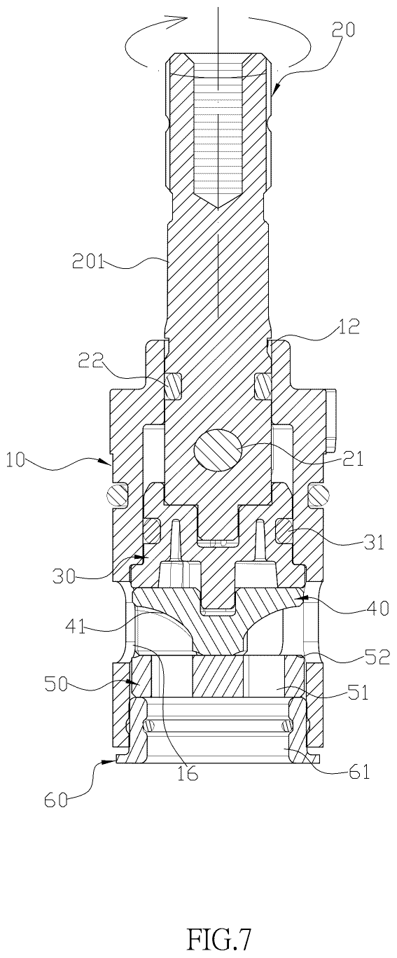

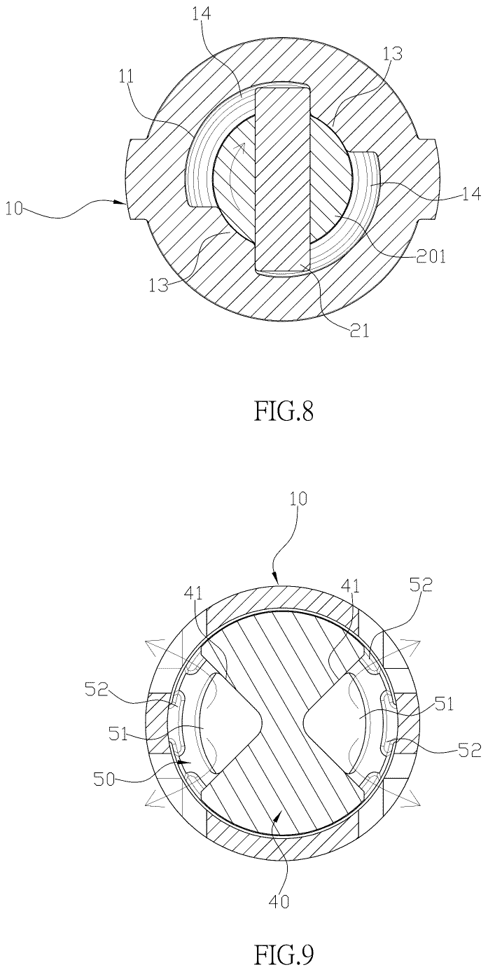

In actual applications, the precision ceramic control valve of this invention is placed in the slot of a water supply device such as a faucet, so that the valve stem 20 is configured for connection with a handle. When the handle drives the valve stem 20 to rotate in one direction, as shown in FIGS. 7 and 8, the through hole 41 of the movable valve disc 40 gradually aligns with the through aperture 51 of the fixed valve disc 50, which allows the water source to be unobstructed by the movable valve disc 40 and to flow from the inlet 61 into the containing space 11, and then out through the through aperture 51, the through hole 41, and the outlet 16, as shown in FIG. 9. During the water supply process, the flow rate can be changed by varying the degree of handle rotation. Conversely, if the handle is turned back, the through hole 41 of the movable valve disc 40 moves away from the through aperture 51 of the fixed valve disc 50, as shown in FIGS. 3 to 6, the water source can be blocked by the misalignment of the movable valve disc 40 and the fixed valve disc 50, thus allowing the water source to be shut off again.

The following benefits can be obtained from the above mentioned structure of the present invention: First, the positioning pin 21 is inserted in the valve stem 20, allowing the positioning pin 21 to rotate in the rotation path 14 driven by the valve stem 20. The rotation angle of the positioning pin 21 is limited by the protrusion of the stopping block 13, thus accurately positioning the open and closed water positions (see FIG. 8), thereby precisely controlling the water supply and achieving a precision ceramic control valve that combines convenience and practicality. Second, the plurality of drain notches 52 are disposed on the upper edge of the fixed valve disc 50, these drain notches 52 promptly discharge impurities flowing between the movable valve disc 40 and the fixed valve disc 50, preventing impurities from accumulating between them and reducing the risk of jamming. Third, the valve stem 20 can utilize the limiting flange 15 to ensures that the valve stem 20 does not deviate. Four, the rotating base 30 is sleeved with the second water-stop ring 31, which incorporates with the first water-stop ring 22, both together provide a double protective seal, preventing water supplied to the containing space 11 from leaking out from the upper port 12, thus providing excellent leak prevention.

Although the present invention has been explained in relation to its preferred embodiment, it is to be understood that many other possible modifications and variations can be made without departing from the spirit and scope of invention as hereinafter claimed.

What is claimed is:

1. An inlet and outlet precision ceramic control valve comprising: a valve housing, a valve stem, a rotating base, a movable valve disc, a fixed valve disc, and a valve base; wherein:
the valve housing has a containing space with an upper port; the valve stem, rotating base, movable valve disc, and fixed valve disc are sequentially placed into the containing space, allowing the valve stem to pass through the valve housing via the upper port; two opposing stopping blocks respectively protrude from an inner wall of the containing space, creating two rotation paths within the valve housing; the upper port has a plurality of limiting flanges, and the containing space has at least one outlet penetrating laterally through the valve housing;
the valve stem has a rod and a driving end connected to the rotating base; a positioning pin is disposed through the rod, both ends of the positioning pin extending horizontally out of the rod; when the valve stem is placed into the valve housing, the rod is capable of passing through the upper port and ensuring that the two ends of the limiting pin extending from the rod are accommodated in the two rotation paths; the limiting flange guides the rod, preventing the rod from skewing during insertion; at least one first water-stop ring and at least one second water-stop ring are respectively sleeved around an outer periphery of the rod and the rotating base;
the movable valve disc has a through hole, and the fixed valve disc has a through aperture, and the movable valve disc and the fixed valve disc are stacked and placed into the containing space of the valve housing, allowing the fixed valve disc to be secured within the valve housing; the movable valve disc engages with the rotating base, and with rotation of the valve stem, the movable valve disc rotates with the rotating base, changing alignment of the through hole the through aperture to control opening and closing of a water supply or alter a flow rate; a plurality of drain notches are disposed on an upper edge of the fixed valve disc, configured to allow impurities flowing between the valve disc and the fixed valve disc to drain away, preventing impurities from accumulating between the movable valve disc and the fixed valve disc;
the valve base being combined with the valve housing prevents the fixed valve disc, the movable valve disc, the rotating base, and the valve stem from falling out of the containing space; and the valve base has a water inlet, allowing water to enter the containing space.

2. The inlet and outlet precision ceramic control valve as claimed in claim 1, wherein the upper port has an inverted triangular limiting flange.

3. The inlet and outlet precision ceramic control valve as claimed in claim 1,
wherein the through hole is a fan-shaped notch extending laterally through a periphery of the movable valve disc.

4. The inlet and outlet precision ceramic control valve as claimed in claim 1, wherein the through aperture is fan-shaped.

5. The inlet and outlet precision ceramic control valve as claimed in claim 1, wherein a periphery of the fixed valve disc has a retaining rib to secure the fixed valve disc within the containing space of the valve housing.
